(19) United States
(12) Patent Application Publication
(10) Pub. No.: US 2026/0038046 A1
(43) Pub. Date: Feb. 5, 2026

(54) NON-FUNGIBLE TOKEN BASED SUSTAINABILITY CREDITS AND MARKETPLACE

(71) Applicant: 4652327 Corporation, Nisku (CA)

(72) Inventors: David KAPLAN, Denver, CO (US); Kelly Adams, Edm (CA)

(21) Appl. No.: 18/877,816

(22) PCT Filed: Jun. 23, 2023
(86) PCT No.: PCT/US2023/069019

§ 371 Date: Sep. 30, 2025

(51) Int. Cl. G06Q 40/04

(52) U.S. Cl. CPC G06Q 40/055; G06Q 40/0431; G06Q 40/049; G06Q 2220/00

(57) ABSTRACT

Systems and methods presented herein provide for a non-fungible token (NFT) sustainability credit marketplace. One system includes a regulating authority platform operable to generate and issue an NFT for a sustainability credit, and an organization platform operable to receive the issued NFT sustainability credit from the regulating authority platform over a network. A trading platform receives the NFT sustainability credit from the organization platform, posts the NFT sustainability credit for sale, conducts a transaction of the NFT sustainability credit between the organization platform and a buyer platform, and instantiates the transaction in a block of a blockchain of the NFT sustainability credit. A plurality of nodes validates the block and manage the blockchain of the NFT sustainability credit.

### CROSS REFERENCE TO RELATED APPLICATIONS

This patent application claims priority to, and thus the benefit of an earlier filing date from, U.S. Provisional Patent Application Nos. 63/355,515 (filed Jun. 24, 2022) and 63/480,456 (filed Jan. 18, 2023), the contents of each of which are hereby incorporated by reference.

### BACKGROUND

A carbon credit is a generic term for any tradable certificate or permit representing the right to emit a certain amount of carbon dioxide or other different greenhouse gases (GHGs). Carbon credits and carbon markets are part of national and international attempts to mitigate the growth in concentrations of carbon dioxide and equivalent GHGs. For example, GHG emissions may be capped for a country by a governmental agency of that country. Then, carbon markets may be used to allocate the emissions among a group of regulated sources (e.g., organizations emitting carbon and other GHGs). With this in mind, the governmental agency may issue carbon credits to the sources based on the amount of carbon dioxide and GHGs that the agency deems acceptable, with each carbon credit typically equaling one metric ton of carbon dioxide or equivalent GHGs. If an organization does not use its entire allotment of carbon credits (i.e., its allowable emissions), that organization can sell its remaining carbon credits to another organization such that the other organization can presumably emit more carbon dioxide and GHGs than it was allotted.

This trading approach provides a market based solution to reducing carbon dioxide and GHG emissions because the price of purchasing additional emissions encourages organizations to reduce their carbon footprint. In other words, carbon credits allow market mechanisms to drive industrial and commercial processes in a direction of lower emissions or less carbon intensive approaches, as opposed to there being no cost to emit carbon dioxide and other GHGs into the atmosphere. And, since GHG mitigation projects of various national governmental agencies generate and allocate credits, the credits can be used to finance carbon and GHG reduction schemes between trading partners around the world.

The quality of the credits, and thus the value of the credits, is generally based on the validation process and sophistication of the organization that acted as the sponsor of the carbon credit. Although it remains in development, it is anticipated that the value and trading of carbon credits will continue to grow particularly as several governments have committed to “green solutions” that reduce carbon and other GHG emissions.

### SUMMARY

Systems and methods herein provide for NFT based sustainability credits and a marketplace for the same. In one embodiment, a system includes a regulating authority platform operable to generate and issue a non-fungible token (NFT) for a sustainability credit, and an organization platform operable to receive the issued NFT sustainability credit from the regulating authority platform over a network. The system also includes a trading platform operable to receive the NFT sustainability credit from the organization platform, to post the NFT sustainability credit for sale, to conduct a transaction of the NFT sustainability credit between the organization platform and a buyer platform, and to instantiate the transaction in a block of a blockchain of the NFT sustainability credit. The system also includes a plurality of nodes operable to validate the block and manage the blockchain of the NFT sustainability credit. The NFT sustainability credit may include, among other things, information pertaining to a contractual obligation of the organization to the regulating authority, a date of issuance of the NFT sustainability credit, and an authorization by the regulating authority to emit, use, and/or produce a material associated with the NFT sustainability credit in compliance with the regulating authority.

In another embodiment, the systems and methods herein provide for NFT based sustainability credits that can be passed onto consumers. In this embodiment, a regulating authority platform is operable to generate and issue a sustainability credit, and an organization platform is operable to receive the issued sustainability credit from the regulating authority platform. The system also includes a consumer platform operable to receive a non-fungible token (NFT) from the organization platform. The NFT is linked to the sustainability credit of the organization platform so that a user of the consumer platform can track the sustainability credit of a company that is in possession of the organization platform.

Additionally, the various embodiments disclosed herein may be implemented in a variety of ways as a matter of design choice. For example, some embodiments herein are implemented in hardware whereas other embodiments may include processes that are operable to implement and/or operate the hardware. Other exemplary embodiments, including software and firmware, are described below.

### BRIEF DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram of an exemplary non-fungible token (NFT) based sustainability credit marketplace.

FIGS. 2A-2D illustrate exemplary NFT sustainability credits.

FIG. 3 is a flowchart of an exemplary process of the NFT based sustainability credit marketplace.

FIG. 4 is a block diagram of an exemplary NFT transaction between a consumer and an organization linked to sustainability credits of the organization.

FIG. 5 is a flowchart of an exemplary process of the NFT transaction of FIG. 3.

FIG. 6 is a block diagram of an exemplary computing system in which a computer readable medium provides instructions for performing methods herein.

### DETAILED DESCRIPTION OF THE DRAWINGS

The figures and the following description illustrate specific exemplary embodiments. It will thus be appreciated that those skilled in the art will be able to devise various arrangements that, although not explicitly described or shown herein, embody certain principles and are included within the scope of the embodiments. Furthermore, any examples described herein are intended to aid in understanding the embodiments and are to be construed as being without limitation to such specifically recited examples and conditions. As a result, the embodiments are not limited to any of the examples described below.

As mentioned, the quality and value of carbon credit trading is generally based on the validation processes and sophistication of the organization that acted as the sponsor of the carbon credit. But governmental agencies can regulate all sorts of materials and create “sustainability credits” for these materials, including carbon and GHGs.

In this regard, the systems and methods presented herein provide for sustainability credits for a variety of materials and a trading platform for such credits using, for example, NFT based transactions. Generally, an NFT is a security consisting of digital asset (e.g., audio, video, images, etc.) and a unique digital identifier recorded in a blockchain, which is used to certify ownership and authenticity. An NFT generally cannot be copied or substituted. A blockchain is a decentralized, distributed, and often public, digital ledger consisting of records called blocks that are used to record transactions across many computers so that any involved block cannot be altered retroactively, without the alteration of all subsequent blocks. More generally, a blockchain is a distributed database or ledger that is shared among the nodes of a computer network. As a database, a blockchain stores information electronically in digital format.

The ownership of an NFT is recorded in the blockchain and can be transferred by the owner to others, allowing NFTs to be sold and traded. Because NFTs are uniquely identifiable, they differ from cryptocurrencies, which are fungible. And, the market value of an NFT is associated with the digital file it references, in this instance, sustainability credits.

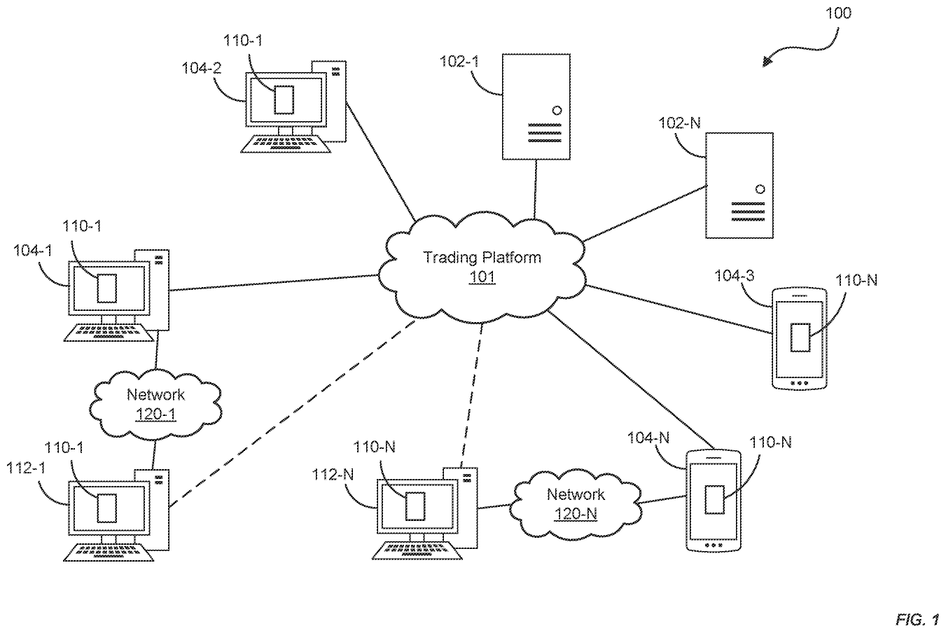

FIG. 1 is a block diagram of an exemplary NFT based sustainability credit marketplace 100. In this embodiment, the marketplace 100 comprises one or more regulating authorities 112-1-112-N (where the reference herein “N” is an integer greater than “1” and not necessarily equal to any other “N” reference designated herein). The regulating authorities 112 generally limit the amounts of certain materials being released into the environment by various organizations 104-1-104-N. For example, organizations such as energy companies that provide electricity and heat contribute to almost ¼ of the world's carbon emissions through the burning of fossil fuels. When a regulating authority 112 establishes a cap for such emissions, the regulating authority 112 may issue credits to the organizations 104 that limit the carbon emissions from the organizations 104. And, when an organization 104 uses all of its allocated credits, the organization 104 may be forced by the regulating authority 112 to cease production/operations or at least cease anymore emissions.

Alternatively, the organization 104 may purchase credits from another organization 104 to continue production/operations. In this regard and in accordance with the embodiments herein, the regulating authorities 112 may issue NFT based sustainability credits 110 to the organizations 104. To illustrate, the regulating authority 112-1 may be responsible for carbon emissions of a particular nation, such as the Environmental Protection Agency of the United States. And, the regulating authority 112-N may be responsible for uranium usage of that nation or another nation, such as the Nuclear Regulatory Commission of the United States. The regulating authority 112-1 may issue carbon credits to the organization 104-1, which falls under the control of the regulating authority 112-1. And, the regulating authority 112-N may issue uranium credits to the organization 104-N, which falls under the control of the regulating authority 112-N. In doing so, the regulating authorities 112-1-112-N may configure sustainability credits as NFTs 110-1-110-N and transfer them to their respective organizations 104-1-104-N over their respective networks 120-1-120-N.

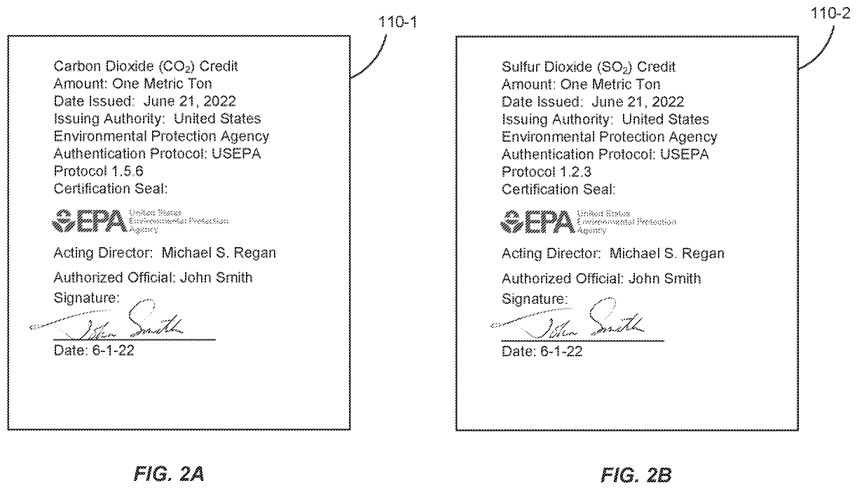

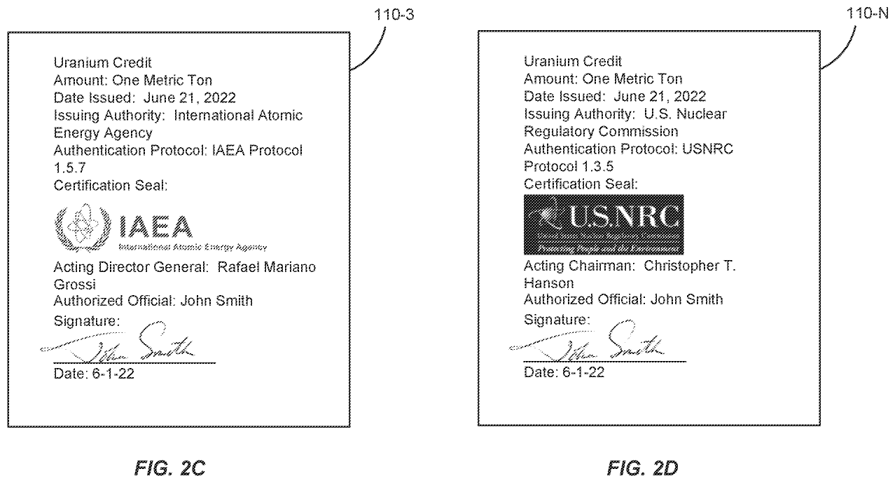

Examples of the NFT based sustainability credits 110-1-110-N are illustrated in FIGS. 2A-2D. For example, in FIG. 2A, the United States Environmental Protection Agency acting as the regulating authority 112-1 may generate and issue (a.k.a. “minting”) an NFT sustainability credit 110-1 that allows the organization 104-1 to emit one metric ton of sulfur dioxide per year. This sustainability credit 110-1 may include, more or less, the legal framework, date of issuance, the issuing authority, the authentication protocols of the issuing authority used in determining the amount of emissions for the organization 104-1, the seal of the issuing authority, the acting director of the issuing authority, and the name and dated signature of an authorized official of the issuing authority. In other words, the NFT sustainability credit 110-1 may include the negotiated and/or contractual obligations of the organization 104-1 to the regulating authority 112-1 pertaining to the emissions of carbon dioxide, as well as the credentials of the regulating authority 112-1. FIG. 2B illustrates a similar NFT sustainability credit 110-2 for emissions of one metric ton of sulfur dioxide. FIG. 2C illustrates a sustainability credit 110-3 for the usage of one metric ton of uranium issued by the International Atomic Energy Agency, and FIG. 2D illustrates an NFT sustainability credit 110-N for the usage of one metric ton of uranium issued by the U.S. Nuclear Regulatory Commission, and

In some embodiments, an NFT sustainability credit 110 credit uniquely carries the monetizable characteristics of the credit in the NFT, and the chain of ownership is carried in the public ledger of the blockchain. For example, a U.S. Airline may purchase $10,000,000 in credits from an organization 104 and the transaction for each and every credit would be traceable to the original generating source (e.g., a regulating authority 112) with high fidelity characteristics. Some other attributes of the NFT sustainability credit 110 residing in the blockchain of the NFT sustainability credit 110 may include the location(s) of the regulating authority 112, location(s) of the organization(s) 104 making the transactions (e.g., longitudes and latitudes of the organizations 104), resources consumed as part of the NFT 110 (e.g., water, gas, nuclear materials, coal, diesel, etc.), and NFT minting fee, an NFT listing fee (e.g. the fee associated with posting on the trading platform 101), the cost of generating the sustainability credit 110, the value of the sustainability credit 110 at the time of generation, sustainability scores, and the like.

In some embodiments, NFT sustainability credits 110 may be issued to organizations 104 when they produce energy that offsets material uses and/or emissions. For example, organizations that employ thermovoltaic devices that produce energy from waste heat may offset energy production from coal-fired power plants. In this regard, a regulating authority 112 may issue NFT sustainability credits 110 to the organization 104 employing such devices as a reward and/or as an incentive to continue “greener” power production. Other types of offsetting technologies may include nuclear power, wind power, solar power, natural gas, and the like. Some offsets that may be instantiated in the NFT sustainability credits may include kilowatt hours, carbon dioxide, sulfur dioxide, nitrous oxide, etc.

In whatever the case, the regulating authority 112 may instantiate the sustainability credit into an NFT that captures the aspects of the sustainability credit. Then, when the regulating authority 112 generates and issues (i.e., mints) the sustainability credit to its respective organization 104, the transaction may be recorded in the blockchain of the NFT. And, the organization 104 may then use and/or emit materials in accordance with its NFT based sustainability credit 110. And, the blockchain of the NFT sustainability credit 110 may track any commissioning fee and any transaction fee(s) throughout the lifetime of the sustainability credit 110.

Assuming that the organization 104 does not use/emit the quantity of materials associated with the sustainability credits 110 it has received, the organization 104 may be free to trade the NFT based sustainability credits 110 on a trading platform 101. For example, assume that the organization 104-1 was issued 100 sustainability credits 110 with each NFT sustainability credit 110 allowing the organization 104-1 to emit one metric ton of carbon dioxide for a calendar year. Now assume that the organization 104-1 only emitted or plans to emit 90 tons of carbon dioxide for that calendar year (e.g., due to investment into greener technologies). The organization 104-1 may transfer ten of its NFT sustainability credits 110 to a trading platform 101 to sell those ten NFT sustainability credits 110 (e.g., either for a set price or as part of an auction). A buyer, such as the organization 104-2, that needs NFT sustainability credits 110 to emit additional amounts of carbon dioxide for that calendar year may purchase one or more of those sustainability credits 110 from the organization 112-1 through the trading platform 101.

In some embodiments, an NFT sustainability credit 110 may be “fractionalized”. For example, when an NFT sustainability credit 110 is minted and issued to an organization 104, the organization 104 may only use a portion of the NFT sustainability credit 110 (e.g., consume an amount of emissions instantiated in the NFT sustainability credit 110). In this regard, the partial NFT sustainability credit 110 may be offered on the trading platform 101. And, the regulating authority responsible for minting the NFT sustainability credit 110 may monitor its use/consumption when transactions are made on the trading platform 101 for the partial NFT sustainability credit 110.

In other embodiments, an organization 104 may mint an NFT sustainability credit 110. For example, an organization 104 that is dedicated to energy production from waste heat using thermovoltaic devices (e.g., thermoelectric generators, or “TEGs)” may offset GHD emissions. And, a regulating authority 112 may allow the organization 104 to mint its own NFT sustainability credits 110 in accordance with the regulating authorities 112 protocols and procedures. Then, the organization 104 may trade these NFT sustainability credits 110 on the trading platform 101. Alternatively or additionally, a regulating authority 112 may mint NFT sustainability credits 110 and then offer them directly on the trading platform 101 for organizations to compete/bid for the NFT sustainability credits 110 on the trading platform 101.

When a transaction for an NFT based sustainability credit 110 is completed, the transaction is recorded in a blockchain maintained by a network of servers 102-1-102-N. For example, a blockchain is a growing list of records, called blocks, that are securely linked together using cryptography. Each block contains a cryptographic hash of the previous block, a timestamp, and transaction data (e.g., generally represented as a Merkle tree, where data nodes are represented by leaves). The timestamp proves that the transaction data existed when the block was published to get into its hash. As blocks each contain information about the block previous to it, they form a chain, with each additional block reinforcing the ones before it. Thus, blockchains are resistant to modification of their data because once recorded, the data in any given block cannot be altered retroactively without altering all subsequent blocks. And, the blockchains of the NFT based sustainability credits 110 may be managed by a peer-to-peer network for use as a publicly distributed ledger, where network nodes such as servers 102-1-102-N collectively adhere to a protocol to communicate and validate new blocks. In some embodiments, the trading platform 101 and block management is implemented at least in part via the Ethereum protocol.

As mentioned, the quality and value of a sustainability credit 110 may be based on the authentication protocols of an issuing regulating authority 112. For example, sustainability credits 110 issued by a regulating authority 112 from an industrious country may not provide the requisite emission controls of another country seeking to reduce its GHG emissions. Accordingly, the sustainability credit 110 from the industrious country may not be useful in the other country and provides no value to organizations 104 in the other country. This may be useful, however, in encouraging the industrious country to engage in practices to reduce its GHG emissions and thereby provide more value to the industrious country's sustainability credits 110.

To illustrate, the United States Nuclear Regulatory Commission likely coordinates with the International Atomic Energy Agency to establish sound policies for uranium usage and uranium waste containment. Accordingly, sustainability credits 110 issued by countries that adhere to the policies and protocols of the International Atomic Energy Agency may find their sustainability credits 110 to be tradable via the trading platform 101 for use in the United States and, thus, be more valuable to the seller.

Examples of the platforms used by the regulating authority 112 and the organizations 104 include, among other things, desktop computers, laptop computers, smart phones, servers, and secure networks. Some examples of materials that may be governed by the NFT based sustainability credits 110 include, among other things, carbon dioxide, sulfur dioxide, other GHGs, uranium, hazardous materials, fertilizers, and the like.

In some embodiments, the regulating authorities 112 may be able to monitor the transactions on the trading platform 101 to provide oversight and ensure that the NFT sustainability credits 110 are being employed in accordance with the protocols of the regulating authorities. And, as the NFT sustainability credits 110 can be considered as assets, the regulating authorities 112 may also monitor the consumption of the NFT sustainability credits 110 to ensure that they are not being “overused” (e.g., emitting GHGs based on a NFT sustainability credit 110 when the amount of emissions associated with the NFT sustainability credit 110 has reached its limit).

In some embodiments, the marketplace 100 is operable to generate a “balancing token” to maintain value of NFT sustainability credits 110. For example, if ten dollars of NFT sustainability credits 110 enter the marketplace 100, those credits may be initially priced at $10. However, if portions of those credits are consumed, there would be a commensurate decrease in value of the NFT sustainability credits 110. The opposite is of course an increase in value if supply is short of demand. In other words, the market demand for the NFT sustainability credits 110 may determine the value for the NFT sustainability credits 110 in the marketplace 100.

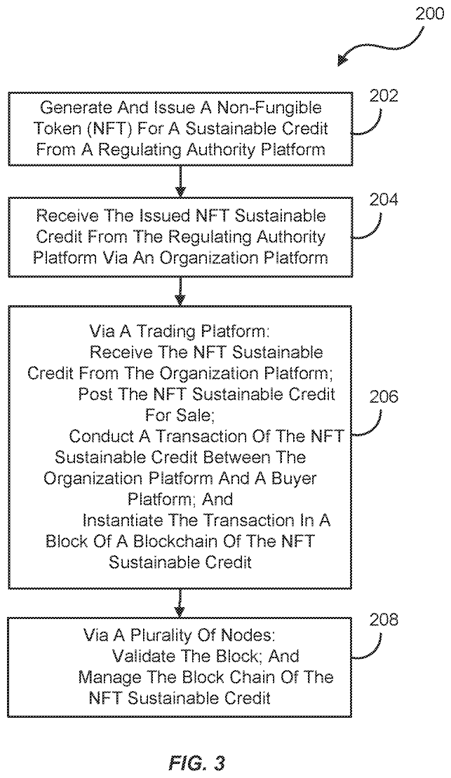

FIG. 3 is a flowchart of an exemplary process 200 of the NFT based sustainability credit marketplace 100. In this embodiment, a regulating authority generates and issues an NFT 110 from its platform 112 for a sustainability credit, in the process element 202. An organization receives the issued NFT sustainability credit 110 from the regulating authority via its platform 104, in the process element 204. Then, assuming that the organization does not require the NFT sustainability credit 110, the organization can attempt to sell the NFT sustainability credit 110 via the trading platform 101, in the process element 206.

In this regard, the trading platform 101 may receive the NFT sustainability credit 110 from the organization platform 112. The trading platform 101 may post the NFT sustainability credit for sale and ultimately conduct a transaction of the NFT sustainability credit between the organization platform 104 and a buyer platform 104. Once the transaction is completed, the trading platform 101 and any associated nodes of the blockchain (e.g., the servers 102, the platforms 104, the platforms 112, etc.) may instantiate the transaction in a block of the blockchain of the NFT sustainability credit 110. And, the nodes associated with the blockchain may be responsible for validating the block and managing the blockchain of the NFT sustainability credit 110, in the process element 208.

Sustainability credits can even be passed onto consumers in the form of NFTs to provide a sort of democratization of the sustainability credits. For example, a company may receive carbon credit either by purchase or by issuance from a governmental agency. And, the company may configure that carbon credit into an NFT, including a QR code, to pass onto the consumer. The NFT being based in a blockchain can be used by the consumer to track how the company uses and/or sells their sustainability credits.

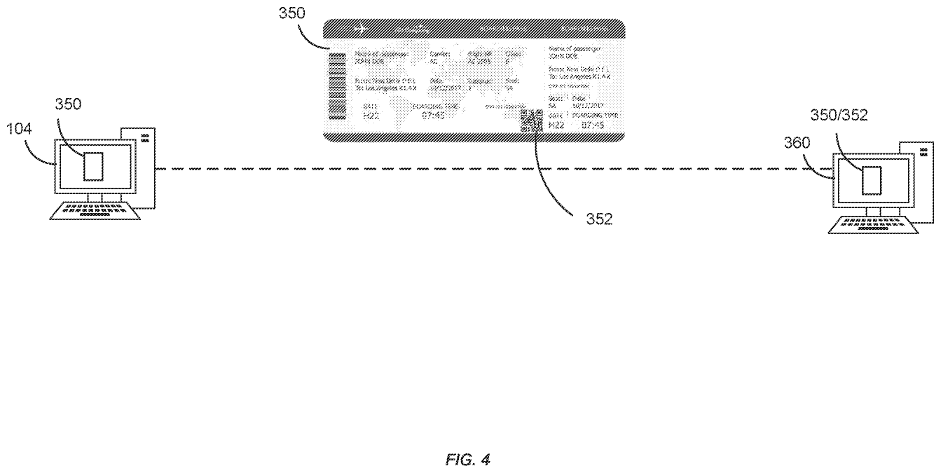

FIG. 4 is a block diagram of an NFT token transaction 350 between an organization platform 104 and a consumer platform 360. In this embodiment, the NFT token transaction 350 is an airline ticket being issued to a customer of an airline. For example, a customer may search for an airline ticket online using the customer's consumer platform 360 (e.g., a desktop computer, a laptop computer, a tablet computer, a smart phone, etc.). When the customer purchases the airline ticket 350 from the airline, the airline may issue a digital copy of the airline ticket and deliver that digital copy of the airline ticket to the customer over the Internet where it may be stored on the customer's consumer platform 360 (e.g., an NFT wallet). In doing so, the airline may embed an NFT token 352 onto the airline ticket. Alternatively or additionally, the digital copy of the airline ticket 350 itself may be the NFT token 352. The NFT token 352 may be linked to one or more sustainability credits of the airline such that the user can track any sustainability credits that the airline may be using in a sort of customer driven accountability for the airline.

While this example illustrates one possible use of the NFT token transaction 350, the example is not intended to be limited to airlines or airline tickets. For example, a beer company may use a plurality of sustainability credits issued to them by a regulatory agency to produce beer. The beer company could then place an NFT token 352 on each label of beer that a customer purchases and consumes. In this example, the NFT token 352 could be a QR code that links to the sustainability credits of the beer company. Generally, the goods and services that could be linked to NFTs are endless. And, the amount of goods and/or services that a consumer may use could be linked to NFT tokens 352 for the consumer to collect and maintain in a consumer's digital NFT wallet.

In some embodiments, the customer can collect a plurality of NFTs to keep track of the customer's sustainability footprint. For example, a customer of a power company may employ solar panels on their home. And, the power company may issue NFT tokens 352 to the customer that illustrate the customer's carbon footprint offset with respect to other customers of the power company. In this regard, when a regulating authority determines that its citizens are required to maintain a certain sustainability footprint (e.g., a carbon footprint), a citizen can use these collected NFT tokens 352 to go outside that sustainability footprint as they deem necessary. Alternatively or additionally, the citizen could sell those NFT tokens 352 to other citizens. The citizen could even buy and/or sell NFT tokens 352 via the above-mentioned trading platform 101.

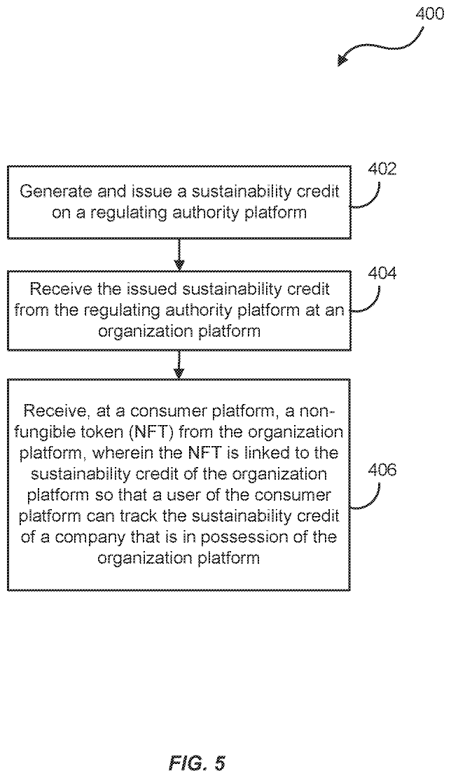

FIG. 5 is a flowchart of an exemplary process 400 of an NFT sustainability credit transaction. In this embodiment, a regulating authority generates and issues sustainability credit 110 from its platform 112, in the process element 402. An organization receives the issued sustainability credit 110 from the regulating authority via its platform 104, in the process element 404. Then, the organization may issue an NFT from its platform to a customer of the organization, in the process element 406. For example, the NFT may be linked to the sustainability credit that the organization received from the regulating authority. With this in mind, the customer can track the sustainability credit of the organization.

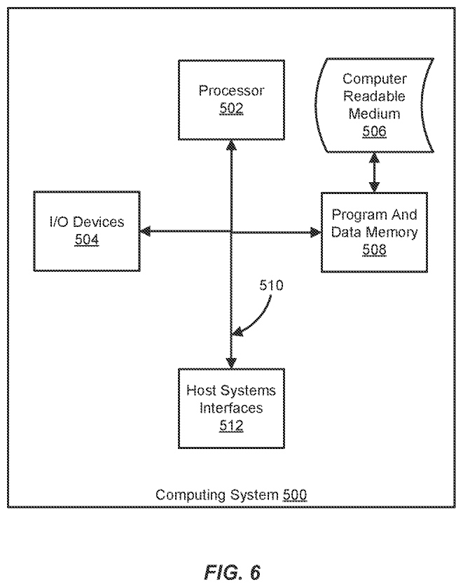

Any of the above embodiments herein may be rearranged and/or combined with other embodiments. Accordingly, the concepts herein are not to be limited to any particular embodiment disclosed herein. Additionally, the embodiments can take the form of entirely hardware or comprising both hardware and software elements. Portions of the embodiments may be implemented in software, which includes but is not limited to firmware, resident software, microcode, etc. FIG. 6 illustrates a computing system 500 in which a computer readable medium 506 may provide instructions for performing any of the methods disclosed herein.

Furthermore, the embodiments can take the form of a computer program product accessible from the computer readable medium 506 providing program code for use by or in connection with a computer or any instruction execution system. For the purposes of this description, the computer readable medium 506 can be any apparatus that can tangibly store the program for use by or in connection with the instruction execution system, apparatus, or device, including the computer system 500.

The medium 506 can be any tangible electronic, magnetic, optical, electromagnetic, infrared, or semiconductor system (or apparatus or device). Examples of a computer readable medium 506 include a semiconductor or solid state memory, magnetic tape, a removable computer diskette, a random access memory (RAM), NAND flash memory, a read-only memory (ROM), a rigid magnetic disk and an optical disk. Some examples of optical disks include compact disk-read only memory (CD-ROM), compact disk-read/write (CD-R/W) and digital versatile disc (DVD).

The computing system 500, suitable for storing and/or executing program code, can include one or more processors 502 coupled directly or indirectly to memory 508 through a system bus 510. The memory 508 can include local memory employed during actual execution of the program code, bulk storage, and cache memories which provide temporary storage of at least some program code in order to reduce the number of times code is retrieved from bulk storage during execution. Input/output or I/O devices 504 (including but not limited to keyboards, displays, pointing devices, etc.) can be coupled to the system either directly or through intervening I/O controllers. Network adapters may also be coupled to the system to enable the computing system 500 to become coupled to other data processing systems, such as through host systems interfaces 512, or remote printers or storage devices through intervening private or public networks. Modems, cable modem and Ethernet cards are just a few of the currently available types of network adapters.

What is claimed is:

1. A system, comprising:
a regulating authority platform operable to generate and issue a non-fungible token (NFT) for a sustainability credit;
an organization platform operable to receive the issued NFT sustainability credit from the regulating authority platform over a network;
a trading platform operable to electronically: receive the NFT sustainability credit from the organization platform; post the NFT sustainability credit for sale; conduct a transaction of the NFT sustainability credit between the organization platform and a buyer platform; and instantiate the transaction in a block of a blockchain of the NFT sustainability credit; and
a plurality of network nodes operable to validate the block and manage the blockchain of the NFT sustainability credit,
wherein the NFT sustainability credit comprises a contractual obligation of the organization to the regulating authority, a date of issuance of the NFT sustainability credit, and an authorization by the regulating authority for the organization to consume a material associated with the NFT sustainability credit in compliance with the regulating authority.

2. The system of claim 1, further comprising:
a consumer platform operable to electronically receive the NFT sustainability credit from the organization platform so that a user of the consumer platform can track the NFT sustainability credit of a company that is in possession of the organization platform.

3. The system of claim 2, wherein:
the user of the consumer platform can retain one or more NFT sustainability credits to track a sustainability footprint of the user.

4. The system of claim 3, wherein:
when a regulating authority implements rules for the user's sustainability footprint, the user can use the one or more NFT sustainability credits in an activity outside of the user's sustainability footprint.

5. A method, comprising:
generating and issuing a non-fungible token (NFT) for a sustainability credit from a regulating authority platform;
receiving the issued NFT sustainability credit from the regulating authority platform via an organization platform over a network;
via a trading platform, electronically:
receiving the NFT sustainability credit from the organization platform;
posting the NFT sustainability credit for sale;
conducting a transaction of the NFT sustainability credit between the organization platform and a buyer platform; and
instantiating the transaction in a block of a blockchain of the NFT sustainability credit; and
via a plurality of network nodes:
validating the block; and
managing the blockchain of the NFT sustainability credit,
wherein the NFT sustainability credit comprises a contractual obligation of the organization to the regulating authority, a date of issuance of the NFT sustainability credit, an authorization by the regulating authority for the organization to consume a material associated with the NFT sustainability credit in compliance with the regulating authority.

6. The method of claim 5, further comprising:
via a consumer platform, electronically receiving the NFT sustainability credit from the organization platform so that a user of the consumer platform can track the NFT sustainability credit of a company that is in possession of the organization platform.

7. The method of claim 6, wherein:
the user of the consumer platform can retain one or more NFT sustainability credits to track a sustainability footprint of the user.

8. The method of claim 7, wherein:
when a regulating authority implements rules for the user's sustainability footprint, the user can use the one or more NFT sustainability credits in an activity outside of the user's sustainability footprint.

9. A non-transitory computer readable medium, comprising instructions that, when executed on one or more processors, directs the one or more processors to:
generate and issuing a non-fungible token (NFT) for a sustainability credit from a regulating authority platform;
receive the issued NFT sustainability credit from the regulating authority platform via an organization platform over a network;
via a trading platform, electronically:
receive the NFT sustainability credit from the organization platform;
post the NFT sustainability credit for sale;
conduct a transaction of the NFT sustainability credit between the organization platform and a buyer platform; and
instantiate the transaction in a block of a blockchain of the NFT sustainability credit; and
via a plurality of network nodes:
validate the block; and
manage the blockchain of the NFT sustainability credit,
wherein the NFT sustainability credit comprises a contractual obligation of the organization to the regulating authority, a date of issuance of the NFT sustainability credit, an authorization by the regulating authority for the organization to consume a material associated with the NFT sustainability credit in compliance with the regulating authority.

10. The computer readable medium of claim 9, further comprising instructions that direct the one or more processors to:
via a consumer platform, electronically receive the NFT sustainability credit from the organization platform so that a user of the consumer platform can track the NFT sustainability credit of a company that is in possession of the organization platform.

11. The computer readable medium of claim 9, further comprising instructions that direct the one or more processors to:
via the consumer platform, retain one or more NFT sustainability credits to track a sustainability footprint of a user.

12. The computer readable medium of claim 11, wherein:
when a regulating authority implements rules for the user's sustainability footprint, the user can use the one or more NFT sustainability credits in an activity outside of the user's sustainability footprint.
